(19) United States
(12) Patent Application Publication
(10) Pub. No.: US 2009/0017683 A1
(43) Pub. Date: Jan. 15, 2009

(54) ELECTRICAL CONNECTOR

(75) Inventor: CHIN-HUANG LIN, TAIPEI COUNTY (TW)

Correspondence Address: ROSENBERG, KLEIN & LEE, 3458 ELLICOTT CENTER DRIVE-SUITE 101, ELLICOTT CITY, MD, 21043, US

(73) Assignee: LONG CHANG TECHNOLOGY CO., LTD., TAIPEI COUNTY (TW)

(21) Appl. No.: 11/842,557

(22) Filed: Aug. 21, 2007

(30) Foreign Application Priority Data
Jul. 11, 2007 (TW) 96211295

(51) Int. Cl. H01R 13/648

(52) U.S. Cl. 439/609

(57) ABSTRACT

An electrical connector includes an insulating body, a plurality of pins, and two connecting bases. The insulating body has a body portion and a connecting portion. The body portion has two receiving spaces. Each pin has a contacting portion and a piercing portion. The pins are disposed in an upper row and a lower row and are installed in the insulating body. The contacting portions extend to the connecting portion of the insulating body. The piercing portions extend into the two receiving spaces. Each connecting base has a plurality of wire slots. Each wire slot is connected with a guiding slot. The two connecting bases are installed in the two receiving spaces. The piercing portions pass through the guiding slots and enter into the wire slots to electrically connect with the conducting wires. Thereby, the manufacturing process is simplified, the cost is reduced, and the environment protection is achieved.

### BACKGROUND OF THE INVENTION

1. Field of the Invention

The present invention relates to an electrical connector. In particular, this invention relates to an electrical connector that is connected with a wire. The assembling process is easy and the cost is reduced.

2. Description of the Related Art

As the electronic devices become smaller and have a variety of functions, the requests for the electrical connector increases, including the strong ability for transmitting signal, a smaller structure, and a simple structure. Currently, high-definition multimedia interface (HDMI) has become a popular input/output interface. HDMI is a new transmission interface for the next-generation multimedia device. The image and the audio do not be transmitted in a separating way again. The maximum transmission speed is 5 Gb/s. It can transmit the image data and 8-channel audio signal.

However, the pin of the HDMI connector is connected with the wire by a welding method. The manufacturing process is complex, the cost is high, and the environment is polluted in the welding process. It does not meet the requirement of the environment protection.

### SUMMARY OF THE INVENTION

One particular aspect of the present invention is to provide an electrical connector. The manufacturing process is simplified, the cost is reduced, and it meets the requirement of the environment protection.

The electrical connector includes an insulating body having a body portion and a connecting portion, a plurality of pins, and two connecting bases. The body portion has two receiving spaces. Each pin has a contacting portion and a piercing portion. The pins are disposed in an upper row and a lower row and are installed in the insulating body. The contacting portions of the pins extend to the connecting portion of the insulating body. The piercing portions of the pins extend into the two receiving spaces of the insulating body. Each connecting base has a plurality of wire slots. Each wire slot is connected with a guiding slot. The two connecting bases are installed in the two receiving spaces of the body portion of the insulating body. The piercing portions of the pins pass through the guiding slots and enter into the wire slots.

The present invention has the following characteristics. A piercing portion is formed at the rear end of the pin and is integrated with the pin into one piece. The pin is electrically connected with the wire by using a piercing method. The manufacturing process is simplified, the cost is reduced, and it meets the requirement of the environment protection.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is an exploded perspective view of the electrical connector of the present invention;

FIG. 2 is a perspective view of the electrical connector of the present invention;

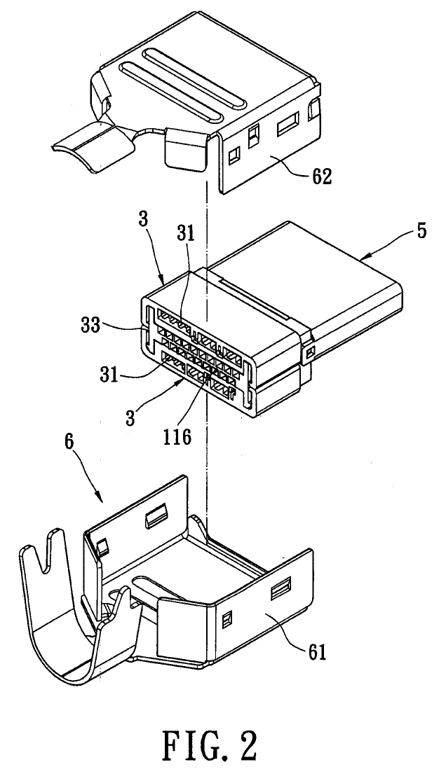

FIG. 3 is an exploded perspective view of part of the electrical connector of the present invention;

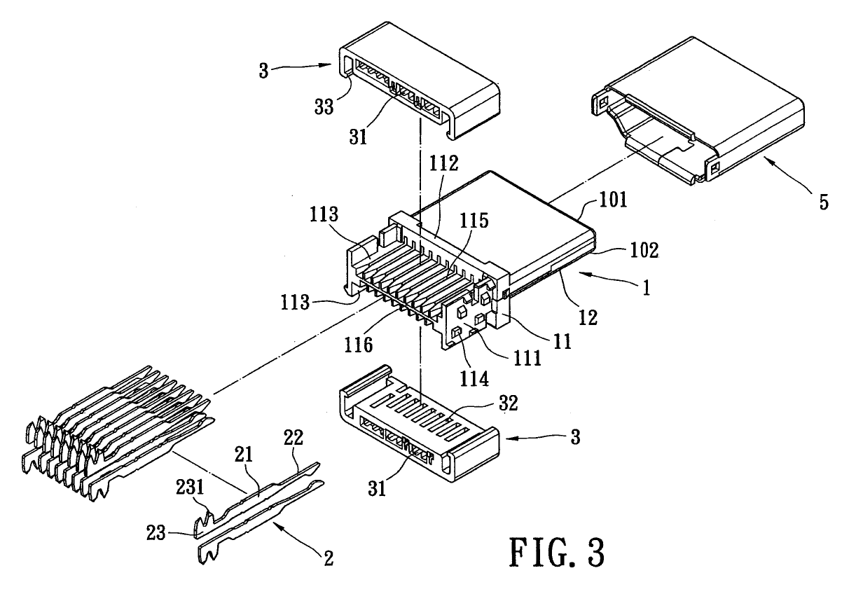

FIG. 4 is a cross-sectional view of part of the electrical connector of the present invention; and

FIG. 5 is a perspective view of the appearance of the electrical connector of the present invention.

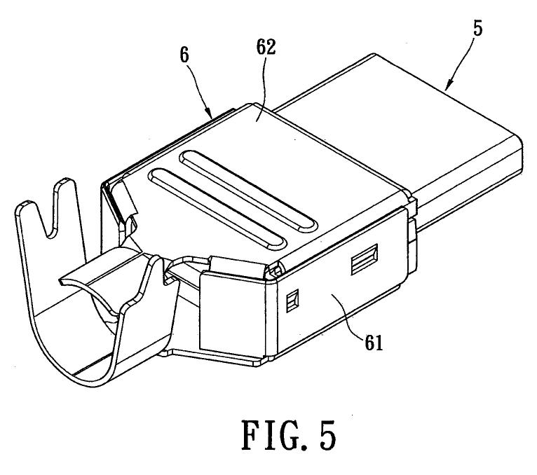

### DETAILED DESCRIPTION OF THE PREFERRED EMBODIMENTS

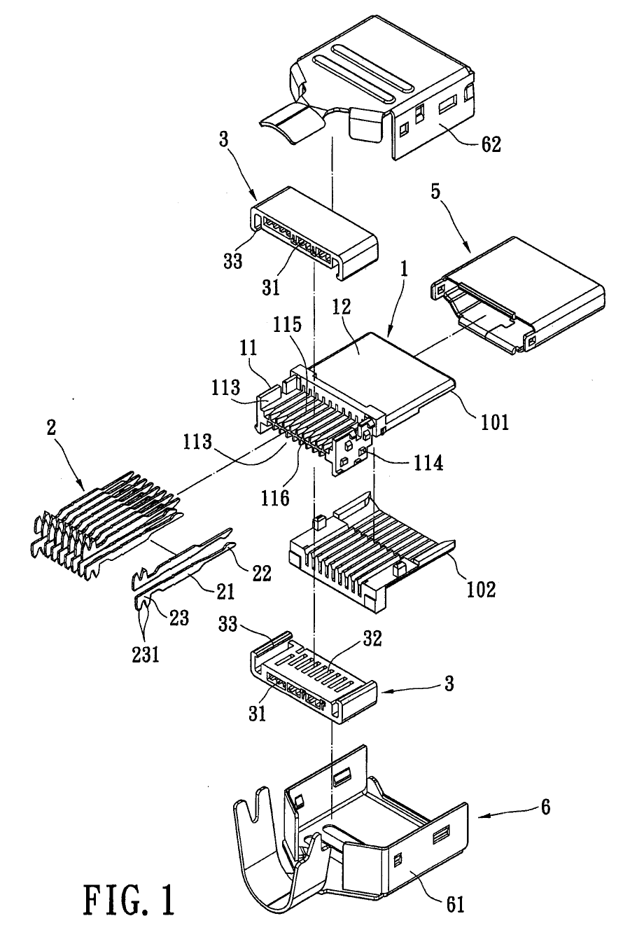

Reference is made to FIGS. 1˜5. The electrical connector of the present invention is used for connecting a wire. In this embodiment, the electrical connector is a HDMI A-type connector. The electrical connector includes an insulating body 1, a plurality of pins 2, two connecting bases 3, and a metal housing 5. The insulating body 1 is made of plastic material, and the insulating body 1 has a body portion 11 and a connecting portion 12. The body portion 11 has two side boards 111 and a front board 112 connected with the front side of the two side boards 111. Two receiving spaces 113 are formed between the two side boards 111 and the front board 112. The two receiving spaces 113 are separated by a separating board 116 and located at the upper side and the lower side. At the outer wall of the two side board 111, there is a plurality of wedging blocks 114.

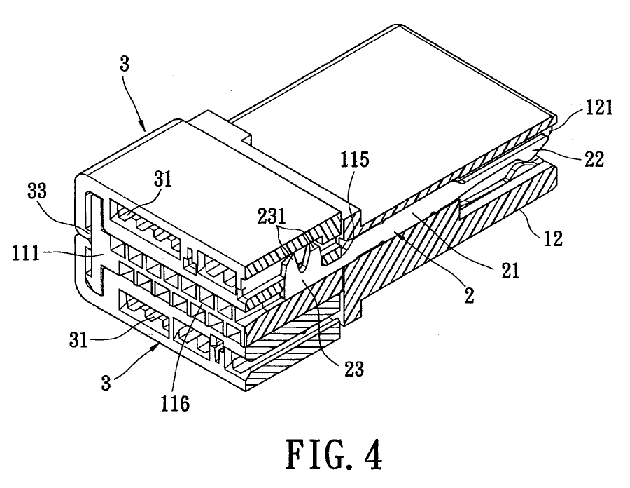

The connecting portion 12 has a flat-board shape. The rear end of the connecting portion 12 is connected with the front board 112 of the body portion 11 so that the connecting portion 12 is connected with the front side of the body portion 11. At the front end of the connecting portion 12, there is a concave plugging opening 121 (refers to FIG. 4). The plugging opening 121 extends backwards to the connecting portion at a proper depth. The connecting portion 12 is used for plugging with the connected electrical connector. At the front board 112 of the body portion 11, there is a plurality of pin-receiving slots 115. The pin-receiving slots 115 extend forwards to the plugging opening 121 of the connecting portion 12 and extend backwards into the two receiving spaces 113. In this embodiment, the insulating body 1 is divided into an upper body 101 and a lower body 102. The upper body 101 and the lower body 102 are assembled together by a wedging method.

The pins 2 are made of conductive and flexible metal material. The pins 2 are disposed in an upper row and a lower row, and the pins at the upper row and the lower row are staggered. Each pin 2 has a fastening portion 21, a contacting portion 22, and a piercing portion 23. The fastening portion 2 has a rectangular-flake shape. The contacting portion 22 is formed by extending from the front end of the fastening portion 21, and the piercing portion 23 is formed by extending from the rear end of the fastening portion 21. The piercing portion 23 has a vertical-flake shape. At the edge of the piercing portion 23, there are two sharp piercing ends 231.

The fastening portions 21 of the pins 2 are respectively installed in the pin-receiving slots 115 of the insulating body 1. The contacting portions 22 extend to the plugging opening 121 of the connecting portion 12 of the insulating body Ito electrically connect the pins of the connected electrical connector. The piercing portions 23 extend into the two receiving spaces 113 of the insulating body 1.

The two connecting bases 3 are made of plastic material. The connecting base 3 is rectangular. Each connecting base 3 has a plurality of wire slots 31. The wire slots 31 extend lengthwise to a proper distance. The wire slots 31 are used for plugging with wires. Each wire slot 31 is connected with a guiding slot 32. The guiding slot 32 passes through one surface of the connecting base 3 from the wire slot 31 so that the piercing portion 23 of the pin 2 passes through the guiding slot 32 and enters into the wire slot 31. At two sides of the two connecting bases 3, each has a wedging hook 33. The wedging hooks 33 correspond to the wedging blocks 114.

The wire is composed of a plurality of conducting lines and an insulating layer covered on the conducting lines. When the electrical connector of the present invention is connected with the wire, the conducting lines and the insulating layer of the wire are plugged into the wire slots 31 of the two connecting bases 3. Thereby, the wire is connected with the two connecting bases 3. Next, the two connecting bases 3 are respectively installed into the two receiving spaces 113 and the user uses the wedging hooks 33 to wedge and lock the wedging blocks 114 so that the two connecting bases 3 are firmly combined with the insulating body 1. Therefore, the piercing portions 23 of the pins 2 pass through the guiding slots 32 and enter into the wire slots 31 and the piercing ends 231 of the piercing portions 23 of the pins 2 pierce through the insulating layer of the wire located in the wire slot 31 and are electrically connected with the conducting lines located in the insulating layer. Thereby, the conducting lines of the wire are electrically connected with the pins 2 located in the insulating body 1.

The metal housing 5 is made metal material. The metal housing 5 is a hollow body having an opening at the front side and the rear side. The metal housing 5 wraps around the connecting portion 12 of the insulating body 1 to provide an excellent protecting effect and an electric-magnetic sheltering effect. Furthermore, the exterior of the electrical connector is wrapped with a metal shell 6. The metal shell 6 includes a shell portion 61 and a covering portion 62. The shell portion 61 and the covering portion 62 are combined together and wrap around the insulating body 1 and the connecting bases 3 of the electrical connector to provide an excellent protecting effect and an electric-magnetic sheltering effect.

The present invention forms a piercing portion 23 at the rear end of the pin 2 and the piercing portion 23 is integrated with the pin 2 into one piece. The pin 2 is electrically connected with the wire by using a piercing method, without using a welding method. It is easy to combine the pin 2 and the wire. The assembling time is reduced. The manufacturing process is simplified, the cost is reduced, and it meets the requirement of the environment protection. Furthermore, the total length of the pin 2 is reduced.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. An electrical connector, comprising:
an insulating body having a body portion and a connecting portion; wherein the body portion has two receiving spaces;
a plurality of pins, wherein each of the pins has a contacting portion and a piercing portion, the pins are disposed in an upper row and a lower row and are installed at the insulating body, the contacting portions of the pins extend to the connecting portion of the insulating body, and the piercing portions of the pins extend into the two receiving spaces of the insulating body; and
two connecting bases, wherein each of the connecting bases has a plurality of wire slots, each of the wire slots is connected with a guiding slot, the two connecting bases are installed in the two receiving spaces of the body portion of the insulating body, and the piercing portions of the pins pass through the guiding slots and enter into the wire slots.

2. The electrical connector as claimed in claim 1, wherein the body portion of the insulating body has a plurality of pin-receiving slots, the pin-receiving slots extend to the connecting portion, each of the pins has a fastening portion, the fastening portions of the pins are respectively installed in the pin-receiving slots of the insulating body, and the contacting portion and the piercing portion of the pins are extended from a front end and a rear end of the fastening portion.

3. The electrical connector as claimed in claim 2, wherein the body portion has two side boards and a front board connected with a front side of the two side boards, the two receiving spaces are formed between the two side boards and the front board, the pin-receiving slots are located at the front board, an front side of the connecting portion has a concave plugging opening, and the pin-receiving slots extend into the plugging opening and the two receiving spaces.

4. The electrical connector as claimed in claim 1, wherein each of two sides of the insulating body has a plurality of wedging blocks, each of the two sides of the two connecting bases has a wedging hook, and the wedging hooks are wedged with the wedging blocks.

5. The electrical connector as claimed in claim 1, wherein the piercing portion of the pin has a vertical flaked shape, the edge of the piercing portion has two sharp piercing ends.

6. The electrical connector as claimed in claim 1, wherein the guiding slots pass through the wire slots to a surface of the connecting base.

7. The electrical connector as claimed in claim 1, further comprising a metal housing, wherein the metal housing wraps around the connecting portion of the insulating body.

8. The electrical connector as claimed in claim 1, further comprising a metal shell, wherein the metal shell wraps around the insulating body and the two connecting bases.

9. The electrical connector as claimed in claim 1, wherein the electrical connector is a HDMI connector.
